(19) United States
(12) Patent Application Publication
(10) Pub. No.: US 2011/0176986 A1
(43) Pub. Date: Jul. 21, 2011

(54) METHOD AND A REACTOR FOR PRODUCTION OF HIGH-PURITY SILICON

(76) Inventor: Christian Rosenkilde, Porsgrunn (NO)

(21) Appl. No.: 12/450,616

(22) PCT Filed: Mar. 14, 2008
(86) PCT No.: PCT/NO2008/000097

§ 371 Date: Mar. 16, 2011

(30) Foreign Application Priority Data
Apr. 2, 2007 (NO) 20071762

(51) Int. Cl. C01B 33/023; B01J 19/00

(52) U.S. Cl. 423/350; 422/129; 422/241; 422/240

(57) ABSTRACT

The present invention relates to a method and equipment for production of high purity silicon by reduction of SiCl₄ with molten Zn metal. The method is characterized in that the reduction takes place in contact with a molten salt that dissolves ZnCl₂. The ZnCl₂ produced during the reduction then dissolves in the molten salt rather than evaporates. The advantage is that gas evolution during the reduction is minimised, leading to higher utilisation of the SiCl₄ and Zn and thereby a higher Si yield. Another advantage is that the molten salt efficiently protects the air sensitive materials, Zn, SiCl₄ and Si, from oxidation during the reduction. The resulting molten salt containing the ZnCl₂ can be used for electrolysis of ZnCl₂ to regenerate the Zn metal. Chlorine evolved during the electrolysis can be used to produce SiCl₄.

A method and a reactor for production of high-purity silicon The present invention relates to a method and equipment for the production of solar grade (high purity) silicon metal from reduction of silicon tetrachloride (SiCl₄) by zinc metal in liquid state.

High purity silicon metal has many applications, of which semiconductor material for the electronic industry and photovoltaic cells for generation of electricity from light are the most important. Presently, high purity silicon is commercially produced by thermal decomposition of high purity gaseous silicon compounds. The most common processes use either SiHCl₃ or SiH₄. These gases are thermally decomposed on hot high purity Si substrates to silicon metal and gaseous by-products.

The presently known processes, in particular the thermal decomposition steps, are very energy intensive and industrial production plants are large and expensive. Any new process addressing these issues and at the same time being able to supply Si metal of sufficient purity is therefore highly desirable.

It has long been known that reduction of high purity SiCl₄ with high purity Zn metal has the potential to yield high purity Si metal. In 1949, D. W. Lyon, C. M. Olson and E. D. Lewis, all of DuPont, published an article in J. Electrochem. Soc. (1949, 96, p. 359) describing the preparation of Hyper-Pure Silicon from Zn and SiCl₄. They reacted gaseous Zn with gaseous SiCl₄ at 950° C., and obtained high purity Si. Later, researchers at the Batelle Columbus Laboratories conducted similar tests, but at a much larger scale. Gaseous SiCl₄ and gaseous Zn was fed to a fluidised bed reactor, where Si granules were formed (see e.g. D. A. Seifert and M. Browning, AlChE Symposium Series (1982), 78(216), p. 104-115). Reduction of SiCl₄ in molten Zn has also been described in various patents. U.S. Pat. No. 4,225,367 describes a process for production of thin films of silicon metal. A gaseous Si-containing species is led into a chamber containing a liquid Zn containing alloy. The gaseous Si-species is reduced on the surface of the alloy and deposits there as a thin Si-film. JP1997-246853, “Manufacture of high-purity silicon in closed cycle”, describes a process for production of high purity silicon. Liquid or gaseous SiCl₄ is reduced with molten Zn to give polycrystalline Si and ZnCl₂. The ZnCl₂ is separated from the Si by distillation and fed to an electrolytic cell where Zn and Cl₂ are produced. The Zn is used for the reduction of SiCl₄ in a separate reactor, while the chlorine is treated with H to give HCl, which is used to chlorinate metallurgical grade Si. Both Zn and Clare thus recycled in the process. The obtained Si had a quality suitable for use in solar cells. A similar process is described in WO2006/100114. A difference between this and JP1997-246853 is that the melting of the Si resulting from the reduction of SiCl₄ with Zn is to be melted, and thereby purified from Zn and ZnCl₂, in the same container as was used for the SiCl₄ reduction. A closed cycle as described in JP1997-246853 is not required.

In all of the above-described known methods for production of high purity silicon by reduction of SiCl₄ with Zn the ZnCl₂ is leaving the reactor as a gas. The vapour pressure of Zn metal is also significant at the operating temperatures, and some Zn will therefore follow the ZnCl₂. Furthermore, since the reaction

SiCl₄+2Zn=Si+2ZnCl₂

is not completely shifted to the right at temperatures above the boiling point of ZnCl₂, the off-gas from the reduction will also contain some SiCl₄. During cooling of the off-gas, SiCl₄ will react with Zn yielding Si and ZnCl₂. The prevailing equilibrium conditions in the reactor therefore yield a ZnCl₂ condensate containing both Zn and Si metal.

In view of the solutions known from the prior art, the present invention represents a novel and vast improvement of a method and equipment for the production of high purity silicon metal from reduction of silicon tetrachloride (SiCl₄) by zinc metal in liquid state, as the reduction reaction as shown above is completely shifted to the right. The method according to the invention is effective and the equipment is simple and cheap to build and operate.

The method according to the invention is characterized by the features as defined in the attached independent claim 1. Further, the equipment according to the invention is characterized by the features as defined in the attached independent claim 11. Claims 2-10 and 12-19 define advantageous embodiments of the invention.

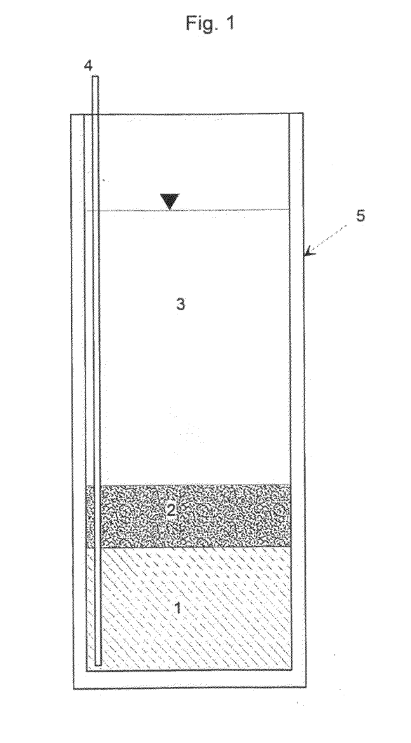

In the following, the present invention shall be described by way of example and with reference to the attached FIG. 1, which shows a principal sketch of a reactor according to the present invention in cross sectional side view.

With reference to FIG. 1 there is shown a reactor 5 for reduction of SiCl₄ by Zn containing beyond a Zn pool 1 at the bottom of the reactor, a liquid layer of Si above the liquid Zn pool and a layer of a suitable salt 3 on top of the Si. In the reactor, reduction of SiCl₄ takes place by bubbling SiCl₄ via a tube, lance or the like 4 through a liquid Zn pool 1 at the bottom of the reactor 5. SiCl₄ may be fed as a gas or a liquid that will evaporate during feeding. Zn metal is added to the reactor either as a liquid or a solid, which in turn will melt due to the existing temperature in the reactor. The tube 4 may have any shape ensuring good reaction between SiCl₄ and Zn. One or several tubes, spinning gas dispersers, or manifold designs represent possible examples of solutions to ensure effective distribution of SiCl₄ to the liquid Zn 1 at the bottom of the reactor 5. The Si resulting from the reaction between Zn and SiCl₄ is during the process collected as a layer 2 between the molten salt 3 and the Zn. Typically, the Si layer consists of a mixture of Si and Zn, which can be removed either by pumping or mechanically by grabbing at regular intervals or continuously. The other product from the reaction between SiCl₄ and Zn, ZnCl₂, dissolves in the molten salt 3 and thereby enriches the molten salt during operation (the reduction process). The molten salt thus enriched with ZnCl₂ can be removed by pumping, grabbing or by flow through suitable channels or tubes. To replace the removed salt, molten salt containing less or no ZnCl₂ may be added to the reactor by pumping, pouring or by flow through suitable channels or tubes.

As stated above the present invention represent a vast improvement of the previously known methods in that the reduction reaction is completely shifted to the right of the reaction: SiCl₄+2Zn=Si+2ZnCl₂. This is accomplished by performing the reduction in contact with a molten salt able to dissolve the formed ZnCl₂. The molten salt has a lower density than the molten Zn where the reduction reaction is taking place and will therefore float on top of the liquid Zn. The ZnCl₂ released during the reduction will float or boil to the top of the metal where it will dissolve in the molten salt. If the temperature of the ZnCl₂ is below the normal melting point it will float, whereas if it is above the boiling point it will rise as bubbles (boil). In either case, the ZnCl₂ will dissolve in the molten salt. The ZnCl₂ therefore remains in the liquid state rather than evaporate as is known from the prior art. ZnCl₂ remains liquid even at temperatures above its normal boiling point. The molten salt also serves to create a barrier between the produced Si and the surrounding atmosphere, thereby preventing oxidation. The molten salt is preferably chloride based, typically consisting of alkali chlorides, alkali earth chlorides, or a mixture thereof. The reduction may be performed both above and below the normal boiling temperature of ZnCl₂. However, the temperature should preferably lie between the normal melting and boiling point of Zn. The molten salt may be the same as that used for molten salt electrolysis of ZnCl₂. The Si produced in the reactor may be removed either continuously or at regular intervals. The molten salt containing the produced ZnCl₂ can be removed either continuously or at regular intervals. It is necessary to replace the molten salt that is removed from the reactor. This can be done either continuously or at regular intervals

As to the design and construction of the reactor 5, several material choices can be made. Since the purpose of the invention is to produce high purity silicon, materials that do not generate too high contamination of the Si must be used. The reactor can be lined with suitable brickwork, e.g. alumina based, silica based, carbon materials, silicon nitride based, silicon carbide based, aluminium nitride based, or combinations of these. It is preferred that the materials in direct contact with the molten salt or the metal are silicon based, i.e. silica, silicon nitride, silicon carbide, or combinations of these. Carbon may also be used.

Even though not shown in FIG. 1, it must also be possible to supply heat (energy) to the reactor. Thus, heating can be accomplished by placing the reactor in a suitable furnace. Induction heating of the molten Zn is also possible, as is resistance heating by passing an electric current through the molten salt.

The reaction SiCl₄ (g)+Zn (l)=2ZnCl₂(l)+Si(s) is slightly exothermic (−130 kJ/mol at 800° C.). During the reduction, the temperature of the molten salt will therefore increase. If the reactor is operated in batch mode, the temperature increase can be controlled by the amount of molten salt relative to the amount of SiCl₄ reacted. The temperature may be brought down again by replacing the ZnCl₂ enriched molten salt by a colder molten salt, or by adding frozen salt. Internal cooling by e.g. coils (not shown in FIG. 1) carrying a suitable cooling medium is also possible. If the reactor is operated in a continuous mode, the temperature can be maintained by adding sufficiently cold molten salt, or by adding a sufficient fraction of frozen salt.

The molten salt typically contains chlorides such as LiCl, NaCl and KCl, but also alkali earth chlorides such as CaCl₂ and other alkali chlorides can be used. Fluoride salts can also be added. The temperature of the reduction can range from the melting point of Zn (420° C.) to the normal boiling point of Zn (907° C.).

The Zn metal can be regenerated by electrolysing (neither not shown) the ZnCl₂ in the molten salt, preferably by direct electrolysis of the molten salt. The molten salt from the reactor is then used as feed for the electrolysis cell(s). Electrolyte from the electrolysis cell(s) may be used to replace the molten salt in the reactor. In this case, a molten salt enriched with ZnCl₂ is fed to the electrolysis cell where ZnCl₂ is electrolysed to Zn metal and chlorine gas, thereby lowering the concentration of ZnCl₂ in the molten salt, which is returned to the reactor. The Zn may also be added to the reactor, while the chlorine can be used for other purposes, e.g. for production of SiCl₄. The equipment may be designed such that the molten salt may flow between the reactor and the electrolysis cell in suitable tubes or channels (not shown). If required, the molten salt can be cooled or heated during transport from the reactor to the electrolysis cell, and vice versa (neither not shown). When Zn is to be regenerated by molten salt electrolysis of ZnCl₂, the present invention has further advantages compared to the prior art. Pure ZnCl₂ is very hygroscopic, has a high vapour pressure and high viscosity in the molten state. On the other hand, the salt containing ZnCl₂ is not very hygroscopic, has a low vapour pressure and viscosity in the molten state. Handling of the salt containing ZnCl₂ is therefore easier than handling pure ZnCl₂.

Operation of the reactor is rather straightforward. Before the first start-up, it is necessary to add molten and Zn metal to the reactor to the desired levels. Then SiCl₄ is added. The SiCl₄ reduction can be run batch-wise or continuously. It is important to ensure that the ZnCl₂ concentration in the molten salt does not get too high, as this may lead to excessive ZnCl₂ evaporation. In a batch mode operation, this limits the amount of SiCl₄ added before molten salt must removed. The silicon metal produced is removed at regular intervals. The levels of the Si and molten salt in the reactor determine the maximum time between Si removals. There will be some Zn and molten salt removed with the Si. These constituents should preferably be recovered by e.g. distillation of the Si. Both Zn and molten salt components are much more volatile than Si. The recovered molten salt and Zn can be returned to the reactor. From time to time, it may be necessary to add or remove Zn and molten salt from the reactor to account for losses or build-up of such materials. At all times it should be ensured that added materials have the sufficient purity to avoid contamination of the Si produced.

1. A method for batch wise or continuous production of high purity silicon (Si) metal from reduction of silicon tetrachloride (SiCl₄) by zinc metal (Zn) in liquid state in a reactor (5),
characterised in that
the Zn reduction of SiCl₄ takes place in the reactor (5) containing, in addition to Si and Zn a molten salt and ZnCl₂ dissolved in the salt.

2. A method according to claim 1
characterised in that
SiCl₄ is fed in a continuous or semi-continuous manner as a gas or as a liquid.

3. A method according to claim 1
characterised in that
SiCl₄ is fed to the liquid Zn through one or several lances.

4. A method according to claim 1
characterised in that
SiCl₄ is fed to the liquid Zn through a spinning gas disperser.

5. A method according to claim 1
characterised in that
SiCl₄ is fed to the liquid Zn through a manifold with several gas exit holes.

6. A method according to claim 1
characterised in that
the produced Si is removed by means of pumping.

7. A method according to claim 1
characterised in that
the produced Si is removed mechanically by means of grabbing.

8. A method according to claim 1
characterised in that
the operating temperature is held between the melting and normal boiling point of Zn

9. A method according to claim 1
characterised in that
the molten salt comprises any of the alkali halides, any of the alkali earth halides, or a mixture thereof.

10. A method according to claim 1
characterised in that
the molten salt containing the ZnCl₂ produced by the reduction reaction is used as feed to a molten salt electrolysis cell to regenerate the Zn metal.

11. Equipment for batch wise or continuous production of high purity silicon (Si) metal from reduction of silicon tetrachloride (SiCl₄) by zinc metal in a reactor characterised in that
the Zn reduction of SiCl₄ takes place in the reactor containing in addition to Si and Zn a molten salt and ZnCl₂ dissolved in the salt.

12. Equipment according to claim 11,
characterised in that
the material in the reactor's and/or electrolyser's lining contains more than 50% SiO₂.

13. Equipment according to claim 11,
characterised in that
the material in the reactor's and/or electrolyser's lining contains more than 5% silicon nitride.

14. Equipment according to claims claim 11,
characterised in that
the material in the reactor's and/or electrolyser's lining contains more than 5% silicon carbide.

15. Equipment according to claim 11,
Characterised in that
the reactor's and/or electrolyser's lining contains more than 5% graphitic material.

16. Equipment according to claim 11,
characterised in that
the feeding device for the SiCl₄ is made of a graphitic material.

17. Equipment according to claim 11,
characterised in that
the feeding device for the SiCl₄ is made of a silica based material.

18. Equipment according to claim 11,
characterised in that
the feeding device for the SiCl₄ is made of a silicon nitride based material.

19. Equipment according to claim 11,
characterised in that
the feeding device for the SiCl₄ is made of a silicon carbide based material.
